(19) United States
(12) Patent Application Publication
(10) Pub. No.: US 2013/0048175 A1
(43) Pub. Date: Feb. 28, 2013

(54) MULTI-CHAMBER INNER TUBE

(71) Applicant: Thomas J. Korus, Lindsay, NE (US)

(72) Inventor: Thomas J. Korus, Lindsay, NE (US)

(73) Assignee: LINDSAY CORPORATION, Omaha, NE (US)

(21) Appl. No.: 13/221,556

(22) Filed: Aug. 30, 2011

(51) Int. Cl. B60C 5/20

(52) U.S. Cl. 152/331.1

(57) ABSTRACT

An inflatable tube having multiple chambers that are independently inflatable and deflatable so that loss of air pressure in one chamber does not result in loss of air pressure in another chamber, the tube being particularly suitable for use with a wheel and tire assembly of an agricultural implement.

### BACKGROUND

1. Field

The present invention relates generally to an inflatable tube. More specifically, embodiments of the present invention concern an inflatable tube having multiple chambers that are independently inflatable and deflatable, the tube being particularly suitable for use with a wheel and tire assembly of an agricultural implement.

2. Discussion of Prior Art

Wheel and tire assemblies are generally provided with or without an inner tube. Inner tubes increase the integrity of wheel and tire assemblies by decreasing the likelihood of air leakage therefrom. At present, nearly all bicycles, many motorcycles, and some large vehicles are equipped with a wheel and tire assembly having an inner tube therein. Air leakage is commonly a result of damage to the inner tube (e.g., puncture) or improper mounting of the inner tube within the wheel and tire assembly.

When a conventional tire and wheel assembly with or without an inner tube begins to lose air pressure, the edge of the tire that connects with the wheel (i.e., the “tire bead”) may be broken. A broken tire bead may result in slippage of the wheel relative to the tire, which causes immobilization of a vehicle to which the tire and wheel assembly is mounted. Thus, it is desirable that air leakage from a wheel and tire assembly be corrected as soon as possible.

Often, it is not possible to correct or otherwise observe air leakage until it is too late, for example, after the vehicle is immobilized. In agricultural applications, where slow-moving vehicles are often utilized in remote areas, immobilization can be especially burdensome. Thus, an interruption in the middle of an agricultural operation may result in considerable downtime and may require duplication of work performed just prior to the interruption. Additionally, given that tires utilized in agricultural applications are generally of considerable size and weight, maintenance of such tires is most efficiently performed using heavy equipment that is not easily transportable to an immobilized vehicle.

### SUMMARY

The following brief summary is provided to indicate the nature of the subject matter disclosed herein. While certain aspects of the present invention are described below, the summary is not intended to limit the scope of the present invention. Embodiments of the present invention provide an irrigation system and method that does not suffer from the problems and limitations of conventional irrigation systems such as those set forth above.

The present invention provides, in its simplest form, a tube having multiple chambers that are inflatable and deflatable independently from each other. In this manner, loss of air pressure or deflation in one chamber (e.g., due to a puncture in the one chamber) does not result in deflation of any other chamber, and a vehicle to which the tube is utilized is not immobilized upon deflation of the one chamber.

The aforementioned aspects are achieved in one aspect of the present invention by providing an inflatable tire tube with a first chamber and a second chamber. The first chamber has an outer connective body and a plurality of inwardly-extending radial elements that each at least partially define a first chamber cavity structure. The outer body and the plurality of inwardly-extending radial elements also define a central enclosed area for receipt of the second chamber. The second chamber has an inner connective body and a plurality of outwardly-extending radial elements that each at least partially define a second chamber cavity structure. The tube, thus, has an annular outer perimeter defined by the first chamber, and an annular inner perimeter defined by the second chamber and one of the plurality of inward-extending radial elements of the first chamber.

In some embodiments, the outer connective body of the first chamber may connect the plurality of inwardly-extending radial elements. Likewise, the inner connective body of the second chamber may connect the plurality of outwardly-extending radial elements. The central enclosed area of the first chamber may include a circular central portion having a plurality of compartments extending therefrom. The plurality of outwardly-extending radial elements of the second chamber may be positioned within the plurality of compartments and between the plurality of inwardly-extending radial elements.

The tube may further include a valve stem extending from each of the plurality of chambers operable to permit independent inflation and deflation of each of the plurality of chambers. For instance, each of the valve stems may extend from the inner perimeter in a radial direction that is about parallel to an extension direction of the plurality of inwardly-extending radial elements of the first chamber and be oriented equidistant from each other about the one side of the tube.

The aforementioned aspects are achieved in another aspect of the present invention by providing an inflatable tire tube with a first chamber having a first cavity defined by a first planar wall and a first non-planar wall, a second chamber having a second cavity defined by a second planar wall and a second non-planar wall, and an abutment region extending continuously between the first planar wall of the first chamber and the second planar wall of the second chamber. The tube may further include valve stems extending outwardly from one of the first non-planar wall and the second non-planar wall in a radial direction therefrom and at an angle between thirty and sixty degrees from the first and second planar wall.

Additional aspects, advantages, and utilities of the present invention will be set forth in part in the description which follows and, in part, will be obvious from the description, or may be learned by practice of the general invention.

### BRIEF DESCRIPTION OF THE DRAWING FIGURES

Embodiments of the present invention are described in detail below with reference to the attached drawing figures, wherein:

FIG. 1 is a front perspective view of a portion of an irrigation system on which a multi-chamber tube in accordance with an exemplary embodiment of the present invention is installed;

FIG. 2 is a top perspective view of the multi-chamber tube illustrated in FIG. 1;

FIG. 3 is a bottom perspective view of the first chamber of the multi-chamber tube illustrated in FIG. 1;

FIG. 4 is a bottom perspective view of the multi-chamber tube illustrated in FIG. 1, illustrating the first chamber and also illustrating a second chamber in cross section;

FIG. 5 is a bottom perspective view of the multi-chamber tube illustrated in FIG. 1, illustrating the second chamber and also illustrating the first chamber in phantom;

FIG. 6 is a bottom perspective view of the multi-chamber tube illustrated in FIG. 1, illustrating the second chamber and also illustrating the first chamber in cross section;

FIG. 7 is a bottom perspective view of the multi-chamber tube illustrated in FIG. 1, illustrating the first chamber and the second chamber in cross section;

FIG. 8 is a bottom perspective view of a multi-chamber tube illustrated in FIG. 1, illustrating the first chamber and a second chamber in cross section similar to FIG. 7 except rotated one hundred and eighty degrees;

FIG. 9 is an elevated side view of a multi-chamber tube illustrated in FIG. 1, illustrating the wheel and tire assembly in cross section;

FIG. 10 is a front perspective view of the multi-chamber tube in accordance with another embodiment of the present invention;

FIG. 11 is a top perspective view of the multi-chamber tube illustrated in FIG. 10 with the first chamber in cross section; and

FIG. 12 is an elevated side view of the multi-chamber tube illustrated in FIG. 10 with the first chamber and the second chamber in cross section.

The drawing figures do not limit the present invention to the specific embodiments disclosed and described herein. The drawings are not necessarily to scale, emphasis instead being placed upon clearly illustrating the principles of the illustrated embodiment.

### DETAILED DESCRIPTION OF THE EXEMPLARY EMBODIMENT

The present invention is susceptible of embodiment in many forms. While the drawings illustrate, and the specification describes, certain embodiments of the invention, it is to be understood that such disclosure is by way of example only. The principles of the present invention are not limited to the particular disclosed embodiments.

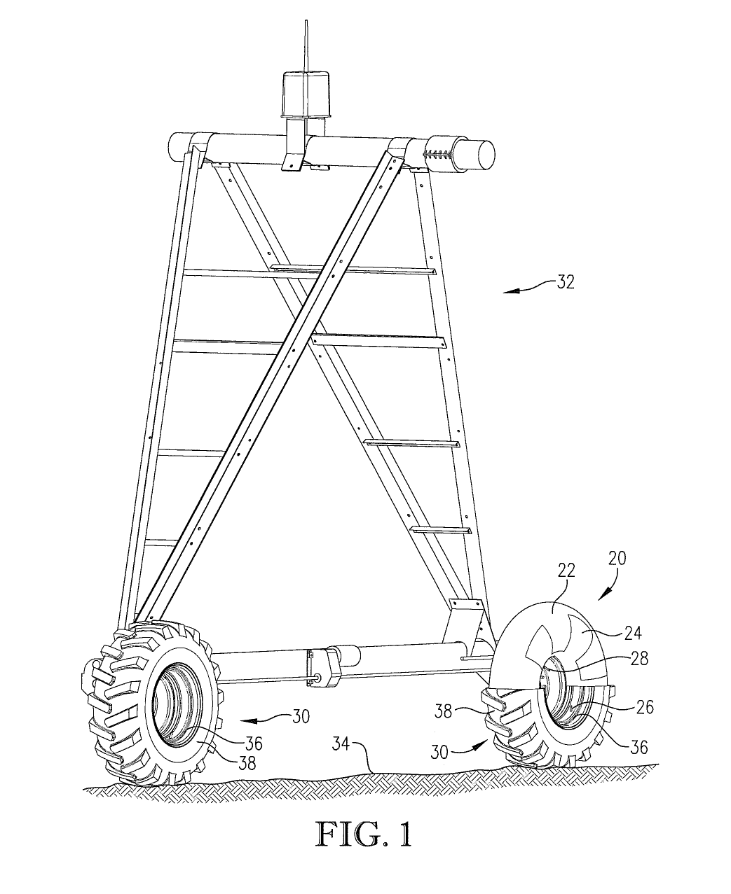

With initial reference to FIG. 1, a multi-chamber inner tube 20 is illustrated and broadly includes an outer or first chamber 22 and an inner or second chamber 24 that are inflatable and deflatable independently from each other via their respective valves 26, 28. The tube 20 is formed of a synthetic rubber or other suitable material that prevents air leakage and has a degree of elasticity. The tube 20 is illustrated in use with a wheel and tire assembly 30 of an agricultural implement 32 to enable traversing thereof across a field 34 with crops (not illustrated) to be irrigated. In the exemplary embodiment, the agricultural implement 32 is a mobile tower for an overhead-irrigation system (not illustrated).

The wheel and tire assembly 30 is connected to the agricultural implement 32 and includes a wheel 36, a tire 38 mounted to the wheel 36, and the tube 20 positioned between the wheel 36 and tire 38. It is foreseen that the tube 20 could be sized and shaped to replace any conventional tube, for instance, as a retrofit tube in a conventional wheel and tire assembly, and/or could be used in any application where no conventional tube was originally used, for instance, as an additional element in a conventional wheel and tire assembly without deviating from the scope of the present invention.

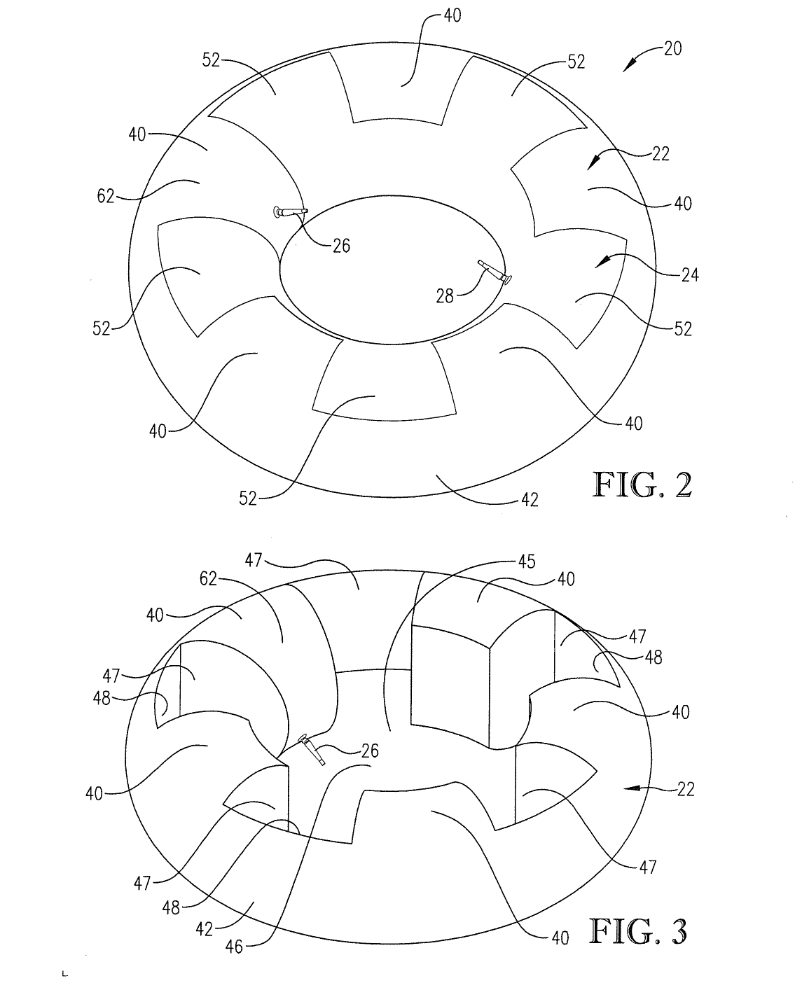

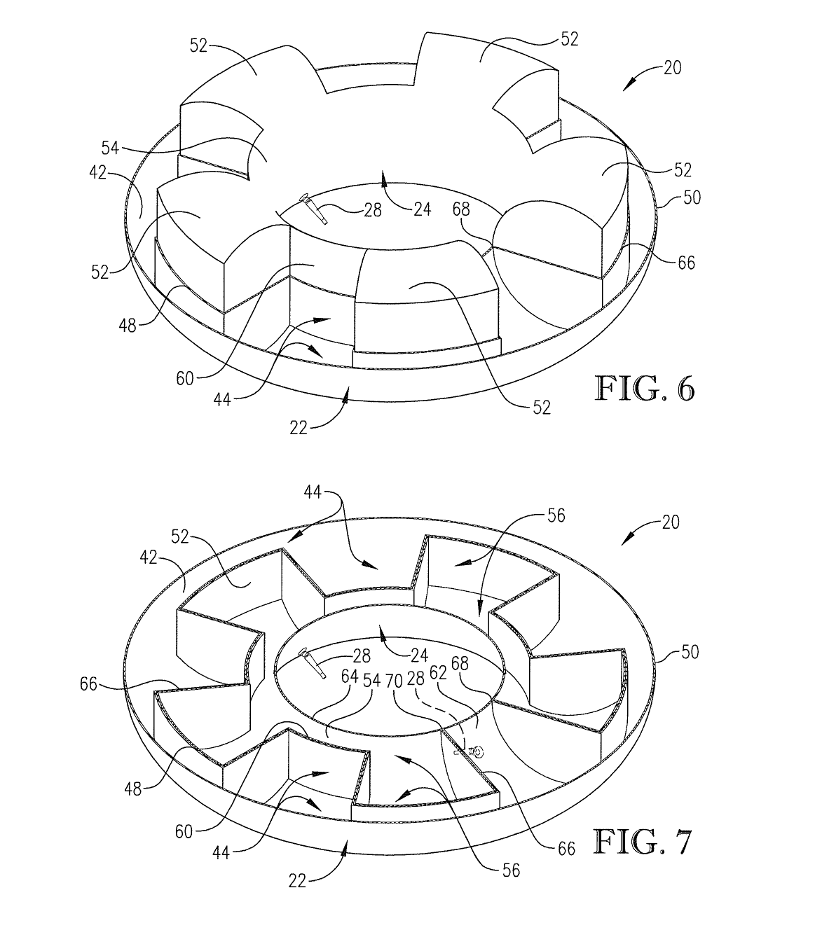

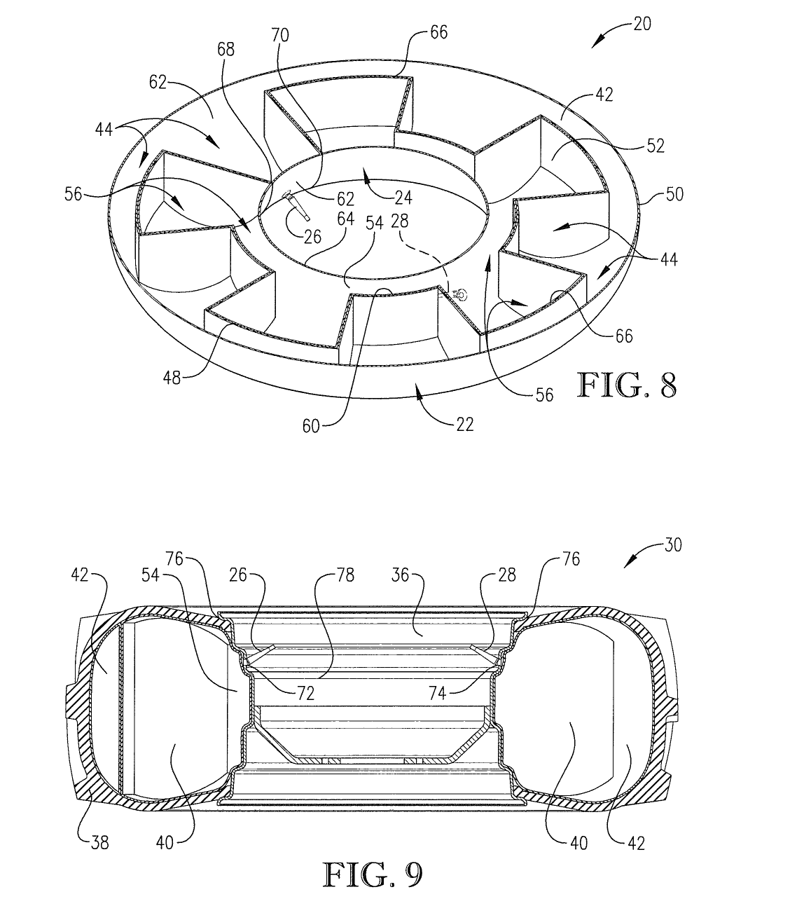

Turning to FIGS. 2-8, the first chamber 22 includes a plurality of inwardly-extending radial elements 40 circumferentially spaced from each other about a circular connecting outer body 42 that connects the plurality of inwardly-extending radial elements 40 to each other. The outer body 42 and the plurality of inwardly-extending radial elements 40 cooperatively define a first chamber cavity structure 44 or chamber that may be inflated with air or other gas or liquid, as illustrated in FIGS. 6-8. The outer body 42 and the plurality of inwardly-extending radial elements 40 also cooperatively define a central enclosed area 45 for receipt of the second chamber 24. The central enclosed area 45 includes a circular central portion 46 and a plurality of circumferentially spaced-apart compartments 47 extending from the central portion 46 and positioned between the inwardly-extending radial elements 40. The plurality of inwardly-extending radial elements 40 and the plurality of compartments 47 have radial lengths equal to each other. The outer body 42 includes an annular inner surface 48 from which the plurality of inwardly-extending radial elements 40 extend. The outer body 42 defines an outermost perimeter 50 of the tube 20. The outermost perimeter 50 is generally the outermost portion of the tube 20 when viewed in a planar cross-section view, such as illustrated in FIG. 7.

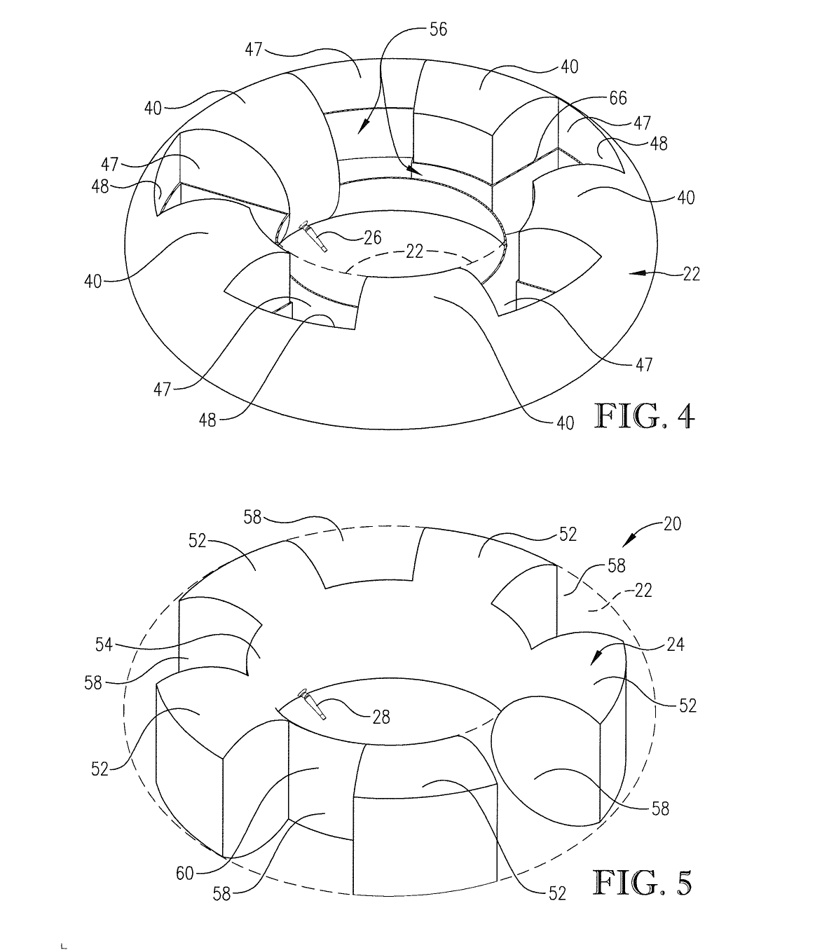

The second chamber 24 is positioned within the central enclosed area 45 of the first chamber 22 and includes a plurality of outwardly-extending radial elements 52 circumferentially spaced from each other about and extending from a circular connecting inner body 54 that connects the plurality of outwardly-extending radial elements 52 to each other. The outwardly-extending radial elements 52 are positioned within the compartments 47 between the inwardly-extending radial elements 40 and the circular connecting inner body 54 is positioned within the central portion 46. The inner body 54 and the plurality of outwardly-extending radial elements 52 cooperatively define a second chamber cavity structure 56 or chamber that may be inflated with air or other gas or liquid, as illustrated in FIGS. 4, 7 and 8. The inner body 54 and the plurality of outwardly-extending radial elements 52 also cooperatively define a plurality of spaced-apart compartments 58 for receiving the inwardly-extending radial elements 40 of the first chamber 22. The inner body 54 includes an annular outer surface 60 from which the plurality of outwardly-extending radial elements 52 extend. The inner body 54 and one inwardly-extending radial element 62 of the plurality of inwardly-extending radial elements 40 cooperatively define an annular innermost perimeter 64 of the tube 20. The innermost perimeter 64 is generally the innermost portion of the tube 20 when viewed in a planar cross-section view, such as illustrated in FIG. 7.

The first chamber 22 and the second chamber 24 have a common abutment region 66 that extends continuously between the first and second chamber 22, 24 from a first point 68 along the innermost perimeter 64 to a second point 70 along the innermost perimeter 64. The first and second points 68, 70 are spaced from each other along the innermost perimeter 64 by the one inwardly-extending radial element 62 of the plurality of inwardly-extending radial elements 40.

The plurality of inwardly-extending radial elements 40 of the first chamber 22 and the plurality of outwardly-extending radial elements 52 of the second chamber 24 are spaced from the outer and inner perimeters 50, 64 and oriented at a common radial distance between or equidistant to the outer and inner perimeters 50, 64. The plurality of inwardly-extending radial elements 40 of the first chamber 22 each have a decreasing width in the direction of extension from the connecting body 42 and the plurality of outwardly-extending radial elements 52 of the second chamber 24 each have an increasing width in the direction of extension from the connecting body 54. As such, the plurality of inwardly-extending radial elements 40 of the first chamber 22 and the plurality of outwardly-extending radial elements 52 of the second chamber 24 have a substantially inverted orientation with respect to each other.

Turning to FIG. 9, the valve stems 26, 28 of the first and second chambers 22, 24 respectively extend from about the innermost perimeter 64 and in a radial direction therefrom that is about parallel to an extension direction of the plurality of inwardly-extending radial elements 40 of the first chamber 22. Additionally, the valve stems 26, 28 are located equidistant from each other about one side of the tube 20, (e.g., along about the innermost perimeter 64 of the tube 20).

When the tube 20 is positioned in the wheel and tire assembly 30 (i.e., between the wheel 36 and the tire 38), each of the valve stems 26, 28 respectively protrudes through apertures 72, 74 in a sidewall 78 of the wheel 36 and a seal or tire bead 76 is formed around a perimeter of the wheel 36 and between the wheel 36 and tire 38. In this manner, the valves 26, 28 are operable to respectively provide access to the first and second chambers 22, 24 for maintenance operations (e.g., inflating and deflating one or both of the first and second chambers 22, 24) without requiring disassembly of the wheel and tire assembly 30 and breaking the tire bead 76 to access the tube 20.

In preparation of use, the wheel and tire assembly 30 is removed from the agricultural implement 32 and disassembled. The tube 20 is installed onto the wheel 36 in a deflated state, (i.e., with the first and second chambers 22, 24 deflated or at least substantially deflated) with the valves 26, 28 oriented such that they respectively protrude through the apertures 72, 74 of the wheel 36. To complete the assembly of the wheel and tire assembly 30, the tire 38 is installed onto the wheel 36 and over the tube 20. The first and second chambers 22, 24 are then inflated via the valve stems 26, 28 to an ideal pressure per-square-inch (e.g., to thirty-four psi), which causes the tire bead 76 to be formed between the wheel 36 and tire 38 and about a perimeter therebetween. To ensure proper inflation, it is desirable to inflate the chambers 22, 24 from an outward radial direction from the wheel 36. In other words, the second chamber 24 is inflated first and the first chamber 22 is inflated second. Such sequential inflation of the chambers 22, 24 ensures the integrity of the tire bead 76. The wheel and tire assembly 30 is then mounted on the agricultural implement 32 to enable traversing thereof across the field 34 or the like.

During use of the present invention, should only one of the chambers 22, 24 become punctured or otherwise experience undesired loss of air pressure, the other non-punctured chamber 22, 24 is operable to maintain its air pressure independent of the punctured one of the chamber 22, 24. In this manner, the other non-punctured chamber 22, 24 is operable to permit continued traversing of the agricultural implement 32 across the field 34 or the like. Additionally, due to the outermost orientation of the chamber 22 relative to the chamber 24, it is more likely that the chamber 22 will become punctured rather than the chamber 24, and that the chamber 24 will maintain the tire bead 76, thus enabling continued traversing of the agricultural implement 32 across the field 34 or the like. Thus, the present invention avoids undesired downtime if the tube 20 becomes punctured or otherwise loses air pressure.

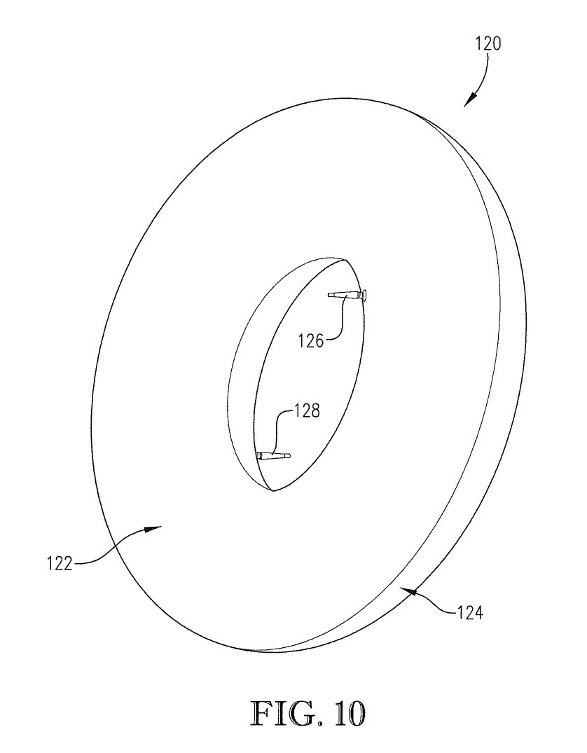

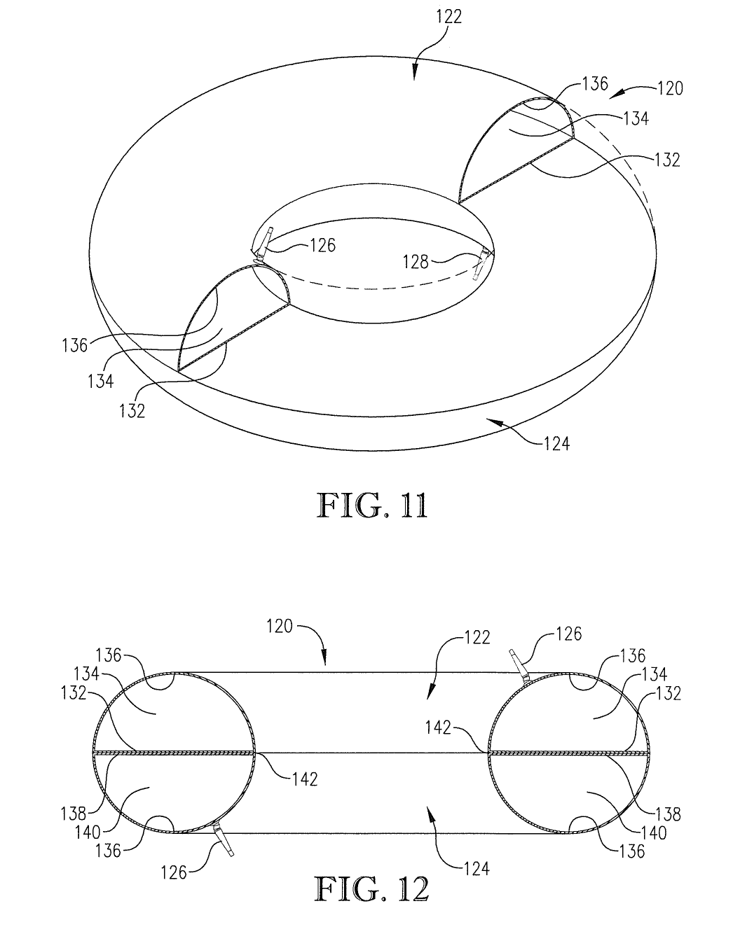

In a second embodiment of the present invention, a multi-chamber inner tube 120 is provided and broadly includes first and second chambers 122, 124 arranged back-to-back and have essentially identical, mirrored designs with respect to each other, as illustrated in FIGS. 10-12. Similar to the exemplary embodiment, the first and second chambers 122, 124 are respectively inflatable and deflatable independently from each via valves 126, 128.

The first chamber 122 includes a first non-planar or curved wall 130 secured at each end thereof to a first planar wall 132. Each end of the first curved wall 130 is spaced from the other along the first planar wall 132 such that a first cavity 134 is defined therebetween. The first valve 126 extends outwardly from the first curved wall 130 in a radial direction therefrom and at an angle between thirty and sixty degrees and approximately forty-five degrees from the first planar wall 132.

The second chamber 124 includes a second non-planar or curved wall 136 secured at each end thereof to a second planar wall 138. Each end of the second curved wall 136 is spaced from the other along the second planar wall 138 such that a second cavity 140 is defined therebetween. The second valve 128 extends outwardly from the second curved wall 136 in a radial direction therefrom and at an angle between thirty and sixty degrees and approximately forty-five degrees from the second planar wall 138. Because the first and second planar walls 132, 138 are parallel to each other, the first and second valves 126, 128 at an angle between thirty and sixty degrees and approximately forty-five degrees from both the first and second planar wall.

The first planar wall 132 of the first chamber 122 and the second planar wall 138 of the second chamber 124 have a common abutment region 142 that extends continuously between the first and second chamber 22, 24. The valve stems 126, 128 extend in opposite directions relative to each other and are respectively located equidistant from each other along the first and second curved walls 130, 136.

In preparation of use, the tube 120 of the second embodiment may be used with a wheel and tire assembly, such as wheel and tire assembly 30, which is removed from an agricultural implement, such as the agricultural implement 32, and disassembled. The tube 120 is installed onto a wheel, such as the wheel 36, in a deflated state, (i.e., with the first and second chambers 122, 124 deflated or at least substantially deflated) with the valves 126, 128 oriented such that they respectively protrude through apertures of the wheel that are oriented to permit the valves 126, 128 to extend through the wheel to enable inflation and deflation of the first and second chambers 122, 124 without disassembling the wheel and tire assembly.

To complete the assembly of the wheel and tire assembly, the tire is installed onto the wheel and over the tube 120. The first and second chambers 122, 124 are then inflated via the valve stems 126, 128 to an ideal pressure per-square-inch (e.g., to thirty-four psi), which causes a tire bead, such as tire bead 76, to be formed between the wheel and tire and about a perimeter therebetween. To ensure proper inflation, it is desirable to inflate the chambers 122, 124 from the inside out relative to the agricultural implement. In other words, the chamber 122, 124 on an interior side relative to the agricultural implement is inflated first and the chamber 122, 124 on an exterior side relative to the agricultural implement is inflated second. Such sequential inflation of the chambers 122, 124 ensures the integrity of the bead. The wheel and tire assembly is then mounted on the agricultural implement to enable traversing thereof across a field, such as the field 34, or the like.

During use of the present invention, should only one of the chambers 122, 124 become punctured or otherwise experience undesired loss of air pressure, the other non-punctured chamber 122, 124 is operable to maintain its air pressure independent of the punctured one of the chamber 122, 124. In this manner, the other non-punctured chamber 122, 124 is operable to permit continued traversing of the agricultural implement across the field. Thus, the present invention avoids undesired downtime if the tube 120 becomes punctured or otherwise loses air pressure.

The embodiments of the present invention described above are to be used as illustration only, and should not be utilized in a limiting sense in interpreting the scope of the present invention. Obvious modifications to the embodiments, as hereinabove set forth, could be readily made by those skilled in the art without departing from the spirit of the present invention. For instance, those skilled in the art will appreciate that the principles of the present invention are not limited to use with a lateral-move irrigation system, but may be employed with other types of irrigation systems.

The inventors hereby state their intent to rely on the Doctrine of Equivalents to determine and assess the reasonably fair scope of the present invention as pertains to any apparatus not materially departing from but outside the literal scope of the present invention as set forth in the following claims.

What is claimed is:

1. An inflatable tire tube comprising:
a first chamber having a plurality of inwardly-extending radial elements, each at least partially defining a first chamber cavity structure;
a second chamber having a plurality of outwardly-extending radial elements, each at least partially defining a second chamber cavity structure;
an annular outer perimeter defined by the first chamber; and
an annular inner perimeter defined by the second chamber and one of the plurality of inward-extending radial elements of the first chamber.

2. The inflatable tire tube of claim 1,
the first chamber including an outer connective body connecting the plurality of inwardly-extending radial elements and at least partially defining the first chamber cavity structure, and
the second chamber including an inner connective body connecting the plurality of outwardly-extending radial elements and at least partially defining the second chamber cavity structure.

3. The inflatable tire tube of claim 2,
the outer connective body and the plurality of inwardly-extending radial elements defining a central portion having a plurality of compartments extending therefrom, and
the plurality of outwardly-extending radial elements positioned within the plurality of compartments and between the plurality of inwardly-extending radial elements.

4. The inflatable tire tube of claim 1, and
a valve stem extending from the one of the plurality of inward-extending radial elements of the first chamber, the valve stem operable to permit inflation and deflation of the first chamber.

5. The inflatable tire tube of claim 1, and
an abutment region extending continuously between the first chamber and the second chamber from a first point on the inner perimeter to a second point on the inner perimeter.

6. The inflatable tire tube of claim 5,
the first point spaced from the second point along the inner perimeter.

7. The inflatable tire tube of claim 5,
the one of the plurality of inward-extending radial cavities of the first chamber spacing the first point from the second point.

8. The inflatable tire tube of claim 1, and
a valve stem extending from each of the plurality of chambers operable to permit independent inflation and deflation of each of the plurality of chambers.

9. The inflatable tire tube of claim 8,
the valve stems extending from the inner perimeter in a radial direction that is about parallel to an extension direction of the plurality of inwardly-extending radial elements of the first chamber.

10. The inflatable tire tube of claim 8,
the valve stems oriented equidistant from each other about one side of the tube.

11. The inflatable tire tube of claim 1,
the plurality of inwardly-extending radial elements of the first chamber and the plurality of outwardly-extending radial elements of the second chamber spaced from and substantially oriented at a common radial distance between the outer and inner perimeters.

12. The inflatable tire tube of claim 2,
the plurality of inwardly-extending radial elements of the first chamber having a decreasing width in a direction of extension from the outer connective body, and
the plurality of outwardly-extending radial elements of the second chamber having an increasing width in a direction of extension from the inner connective body.

13. The inflatable tire tube of claim 1,
the plurality of inwardly-extending radial elements of the first chamber and the plurality of outwardly-extending radial elements of the second chamber having a substantially inverted orientation with respect to each other.

14. An inflatable tire tube comprising:
a first chamber having a first cavity defined by a first planar wall and a first non-planar wall;
a second chamber having a second cavity defined by a second planar wall and a second non-planar wall; and
an abutment region extending continuously between the first planar wall of the first chamber and the second planar wall of the second chamber.

15. The inflatable tire tube of claim 14, and
a valve stem extending from the first non-planar wall of the first chamber and the second non-planar wall of the second chamber, each of the valve stems operable to permit independent inflation and deflation of the first and second chambers.

16. The inflatable tire tube of claim 15,
the valve stems extending outwardly from one of the first non-planar wall and the second non-planar wall in a radial direction therefrom and at an angle between thirty and sixty degrees from the first and second planar wall.

17. The inflatable tire tube of claim 15,
the valve stems oriented equidistant from each other about opposite sides of the tube.
